(19) United States
(12) Patent Application Publication
(10) Pub. No.: US 2025/0281937 A1
(43) Pub. Date: Sep. 11, 2025

(54) SPRAY NOZZLE WITH IMPROVED SPRAY COVERAGE

(71) Applicant: Evapco, Inc., Baltimore, MD (US)

(72) Inventors: Zachary Russell, Hanover, PA (US); Aaron Reilly, Littlestown, PA (US); Wayne Sexton, Lovettsville, VA (US); Mark Huber, Sykesville, MD (US)

(21) Appl. No.: 19/073,460

(22) Filed: Mar. 7, 2025

Related U.S. Application Data
(60) Provisional application No. 63/562,558, filed on Mar. 7, 2024.

(51) Int. Cl. B05B 1/04

(52) U.S. Cl. CPC B05B 1/048

(57) ABSTRACT

A water spray nozzle for evaporative cooling equipment having a D-shaped bore with an internal diameter across the widest portion of the flat portion of the D-shape of 2 inches or greater, capable of casting water about a radius of 170 degrees or greater six feet or greater at 1 psi of pressure. A single body two bore device provides 360 degrees of water spray of 6 feet or more at 1 psi. A flat or planar portion at the top of the flat portion of the D-shaped bore improves nozzle performance.

### BACKGROUND OF THE INVENTION

### Field of the Invention

The present invention relates to spray nozzles for evaporative cooling equipment.

### Description of the Background

Typical evaporative cooling equipment includes a pressurized water distribution system that applies a water spray to heat exchange media (such as coils or cooling tower fill). This water distribution usually includes multiple “spray branch” or “lateral” pipes with nozzles attached that disperse the water flowing through the pipes over the heat exchange media in the form of a spray. The ability of the water distribution system to uniformly distribute the flow of water can have a significant impact on the efficiency of the cooling equipment.

Typically, multiple parallel lateral pipes are required with many nozzles installed on each lateral pipe to achieve spray water coverage over the entire heat exchange media. The nozzle described in U.S. Pat. No. 4,058,262 (“Bete model IS nozzle”) produce a rectangular coverage area by installing the nozzles in interacting pairs. They are commonly used in factory assembled evaporative cooling towers having a size suitable for placing on a truck bed for transportation to an installation location. Spray nozzles that effectively cover a large area are desirable because the quantity of nozzles and/or laterals in the water distribution system is decreased and therefore the cost of the water distribution system is decreased.

The type and quantity of the spray nozzles will have a large impact on the operating pressure of the water distribution system at a given flow. Operating pressure directly affects the size and therefore the cost of the pumping system required to supply water to the evaporative cooling equipment. Therefore, a water distribution system that performs well at a lower pressure is desirable.

### BRIEF DESCRIPTION OF THE DRAWINGS

The following detailed description of the invention will be better understood when read in conjunction with the appended drawings. For the purpose of illustrating the invention, there are shown in the drawings various embodiments which are presently preferred. It should be understood, however, that the invention is not limited to the precise arrangements and instrumentalities shown. In the drawings:

FIG. 1 is a bottom cutaway view of an experimental scaled-up and bored-out version of a Bete model IS nozzle.

FIG. 2 is a closeup of two adjacent nozzles of FIG. 1 in an evaporative cooling tower water distribution system.

FIG. 3 is a computer analysis of the water flow patterns of the configuration of FIG. 2.

FIG. 4 is a bottom cut-away view of a nozzle having a D-shaped internal bore according to an embodiment of the invention.

FIG. 5 is a comparison showing the different water distribution patterns between an experimental nozzle of FIG. 1 (left side) and a nozzle having a D-shaped bore according to the invention (right side).

FIG. 6A is a perspective view of a nozzle according to an embodiment of the invention.

FIG. 6B is a cross-sectional view of the nozzle of FIG. 6A.

FIG. 7 is a side view of a double-threaded nozzle according to an embodiment of the invention.

FIG. 8 is a top down view of two 6′×6′ bays of a cooling tower having two spray headers with prior art nozzles.

FIG. 9A is a side view of two nozzles according to a first embodiment of the invention arranged back-to-back.

FIG. 9B is a top down view of two 6′×6′ bays of a cooling tower having a single spray header with nozzles according to a first embodiment of the invention arranged back-to-back.

FIG. 10 is a side view of a single body, two D-shaped bore nozzle according to a second embodiment of the invention.

FIG. 11 is a perspective view of the single body, two D-shaped bore nozzle of FIG. 10.

FIG. 12 is a cross-sectional view of a single body two D-shaped bore nozzle according to a third embodiment of the invention in which the wall separating the two D-shaped bores is tapered on top to form two flat slanted surfaces facing in opposite directions.

FIG. 13 is a cross-sectional view of a two D-shaped bore nozzle according to a fourth embodiment having separate nozzle and pipe adapter parts.

FIG. 14 is a perspective view of the nozzle part of the embodiment of FIG. 13.

FIG. 15 is a perspective view of the pipe adapter part of the embodiment of FIG. 13.

### DETAILED DESCRIPTION OF THE INVENTION

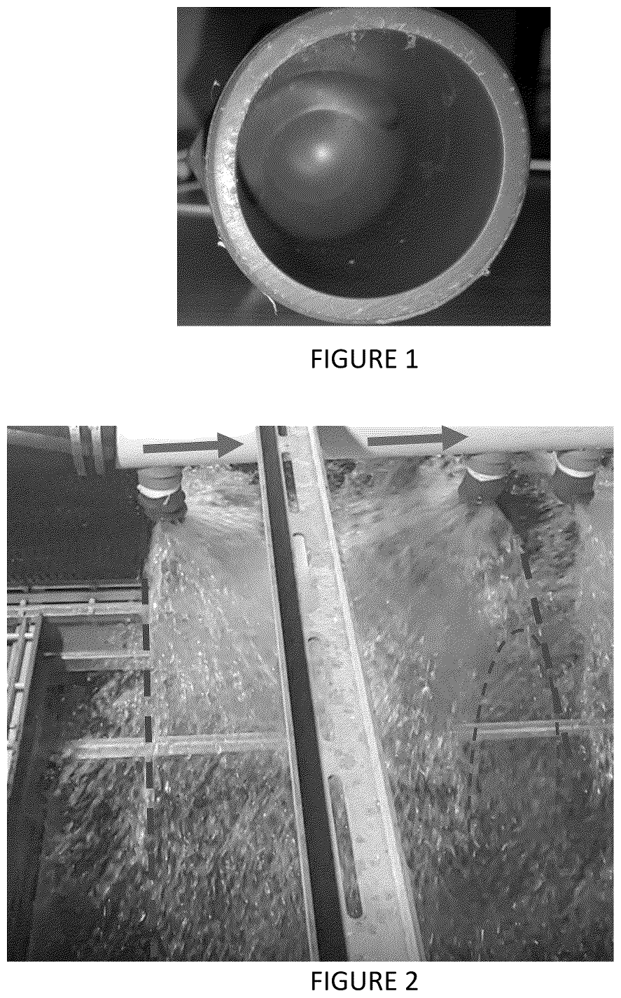

Using large numbers of Bete model IS nozzles for evaporative cooling equipment is expensive and labor intensive. Accordingly, the inventors attempted to scale-up the size of Bete model IS nozzles for use in evaporative cooling equipment in order to reduce cost and installation/replacement/repair labor. Requirements for the new nozzle included at least a 6-foot throw of water about 170 degrees or greater (preferably 180 degrees or greater) at 1 psi of pressure with a 2 inch or 3 inch connection to a 6-inch or 8-inch water supply branch. In addition to being proportionally larger than standard 1.5-inch Bete model IS nozzles, the inventors' first experimental scaled-up nozzle featured a larger bore (FIG. 1) relative to the overall size of the nozzle, as compared to the prior art Bete model IS nozzles in order to reduce operating pressure of the nozzle and reduce material costs as compared to a proportionally accurate scaled-up Bete model IS nozzle.

However, the first experimental scaled-up version of the Bete model IS nozzle with the proportionally wider bore produced an undesirable spray pattern with a decreased water coverage area. FIG. 2 shows a pair of experimental scaled-up Bete model IS nozzle having an increased inner bore diameter of FIG. 1. The blue arrows indicated the direction of water travel in the lateral feed pipe. The nozzles are attached to the lateral feed pipe by threaded adapters. The nozzle on the left operated satisfactorily, producing a water coverage area extending to and beyond the dashed line indicating the desired coverage limit at a plane tangential to the back surface of the nozzle. The nozzle on the right, however, identical in structure to the nozzle on the left, produced a significantly deficient water coverage area in which the area shown in the dashed oval was significantly under-watered.

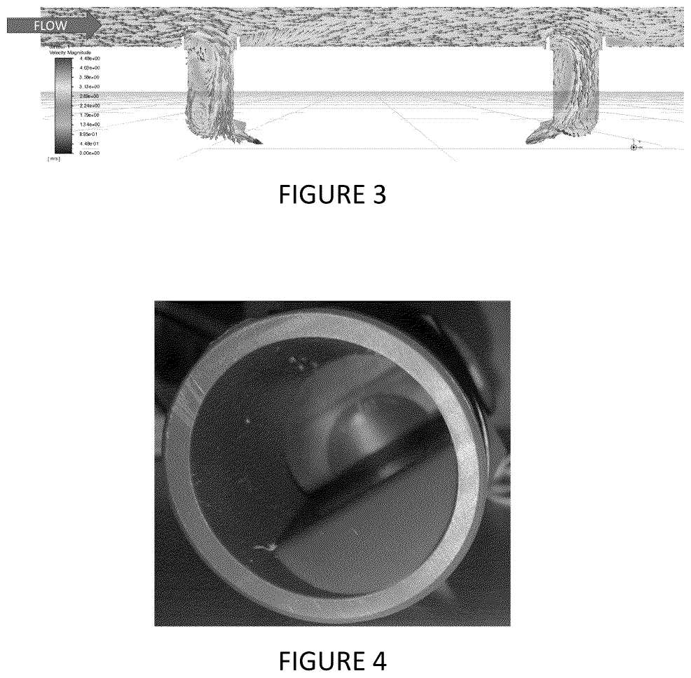

The inventors thus discovered that increasing the overall size of a Bete model IS nozzle, with a proportionally larger increase in the relative size of the bore causes the resulting nozzle to be sensitive to the direction of flow in the pipe. That is, the nozzle on the left in FIG. 2 shows the spray of the experimental nozzle when it is oriented to spray water in the same direction as the direction of water flow in the lateral feed pipe, which produces a satisfactory spray pattern. The nozzle on the right in FIG. 2 shows the spray of the exact same experimental nozzle when it is oriented to spray water in a direction opposite to the direction of water flow in the lateral feed pipe, which produces an unsatisfactory spray pattern, as shown by the dashed oval. To understand this phenomenon, the inventors analyzed the internal flow characteristics through the lateral feed pipe and the experimental nozzles, see FIG. 3. Based on the observations represented in FIG. 2 and the analysis of FIG. 3, the inventors concluded that due to internal flow patterns, the first experimental nozzles can only produce a desirable spray when the nozzle is oriented so the direction of spray is the same as the flow of water in the lateral feed pipe. The problem thus was developing a large-scale, large bore (greater than 2 inches) spray nozzle for evaporative cooling equipment that produces a satisfactory spray pattern/coverage area without regard to whether the nozzle is oriented so the direction of spray is the same as the direction of water flow in the lateral feed pipe or opposite to the direction of water flow in the lateral feed pipe.

A first solution/embodiment presented herein to this problem is a large-scale large bore spray nozzle in which the central bore has a D-shaped cross-section, (see experimental nozzle #2 with a D-shaped bore, FIG. 4, and compare to the cylindrical bore of the first experimental nozzle, FIG. 1).

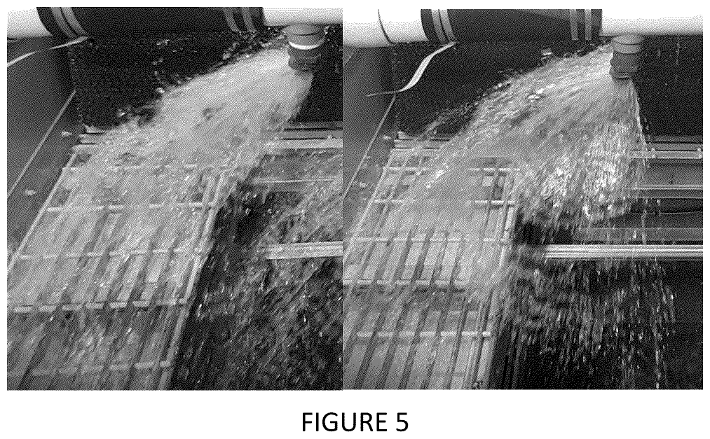

Physical testing confirmed that the spray pattern is significantly improved with a large bore nozzle having a D-shaped cross section or profile. FIG. 5 shows the improved spray pattern of a pair of nozzles with the “D” shaped cross section (right) versus the round inner cross section (Left). These large-bore D-shaped nozzles (2 inches or greater across the flat portion of the D-shaped bore) were demonstrated to cast a 180 degree or better spray 6 feet or more at 1 psi of pressure.

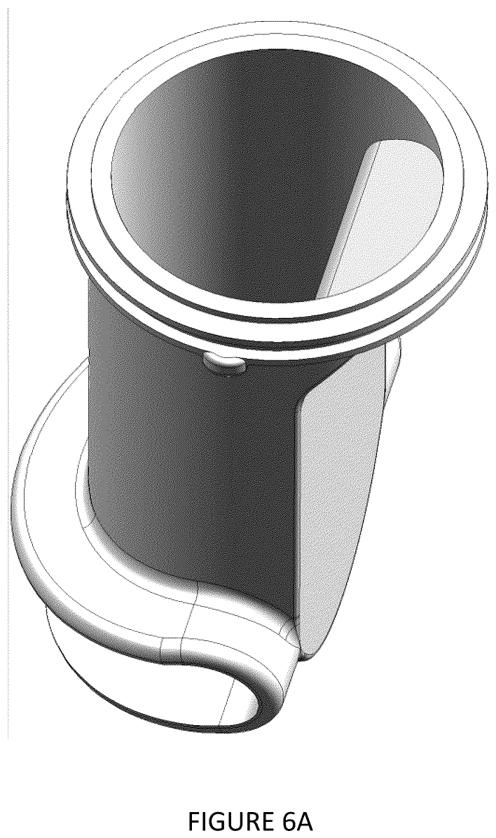

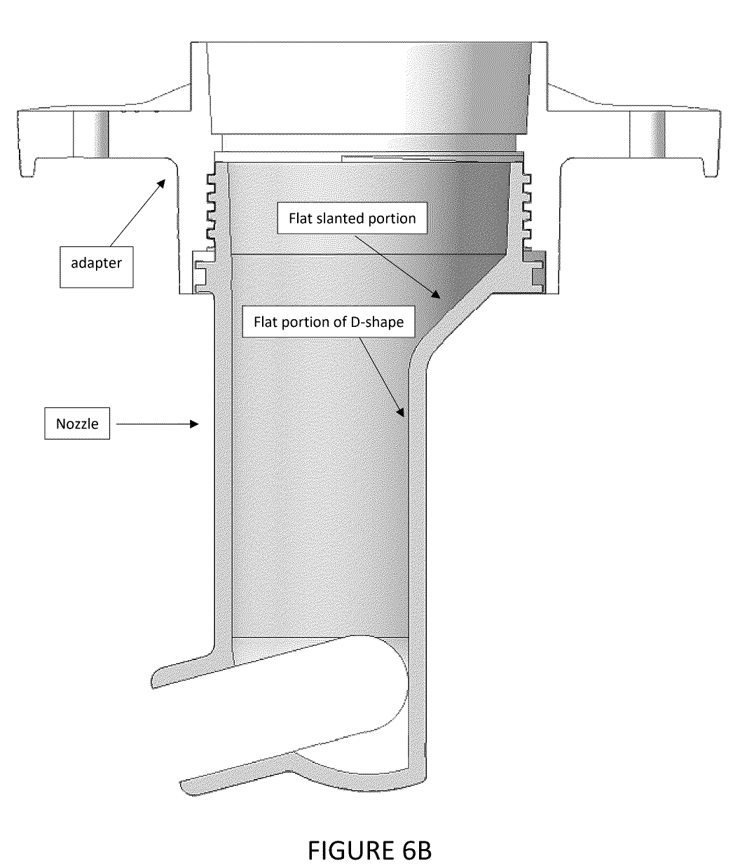

To save material, rather than filling in a portion of a round bore to form the D-shaped bore, as shown in FIG. 4, the body of nozzles according to this embodiment may be formed to match the shape of the D-shaped bore, such that the external shape of the nozzle body has a flat side and a curved side, see FIGS. 6A and 6B. According to this embodiment, the top of the flat side has a flat/planar tilted portion that widens the bore and the body at the top to terminate at a round threaded portion configured to interface with the spray branch directly, or, as shown in FIGS. 6A and 6B, with a pipe adapter part. Surprisingly, the internal slanted surface at the top of the flat side of the “D,” was discovered to further improve the spray pattern.

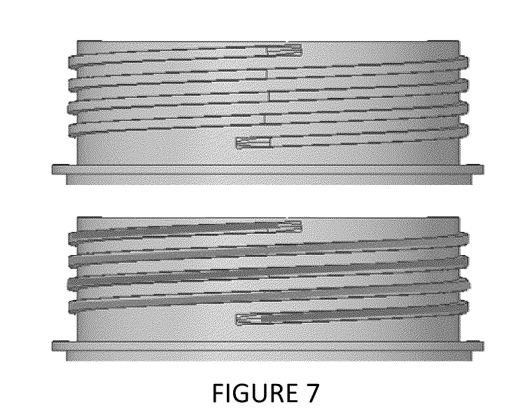

It is important that the nozzle is aligned correctly when threaded into the spray branch or spray branch adapter. Over- or under-rotation will prevent a pair of adjacent facing nozzles from interacting correctly and creating the desired spray pattern. Accordingly, the mating male and female portions of the nozzle and the adapter may feature a double set of threads (FIG. 7) so that they lock together in the correct orientation to prevent or avoid over or under rotation during field installation. The nozzles described above are installed in pairs, back-to-back, facing opposite directions, along the spray branch. By using double-start threads on the nozzle and adapter, the nozzle can be installed in the adapter in both directions. The threads are arranged so that the ending orientation of the nozzle when fully screwed in, is known based on the starting orientation, when the threads are first engaged. Since two thread sets are provided with double-start threads, two different sets of beginning and ending orientations may be configured. According to a preferred embodiment, the orientation of the nozzle, when fully screwed in, is the same as its orientation when the threads are first engaged. When a “left-facing” nozzle is screwed into the pipe or the adapter, with the nozzle facing left when the threads of the nozzle first engage a first set of the two thread sets. Conversely, a “right-facing” nozzle is screwed into the pipe or the adapter, with the nozzle facing right when the threads of the nozzle first engage a second set of the two thread sets. According to this arrangement, an installer need only make sure the nozzle is facing the correct direction when first starting to screw the nozzle into the adapter (or directly into the spray branch pipe), and it will wind up facing the correct direction when it is fully seated. This way the proper nozzle orientation can be achieved independent of the adapter orientation even when a locking mechanism is in place.

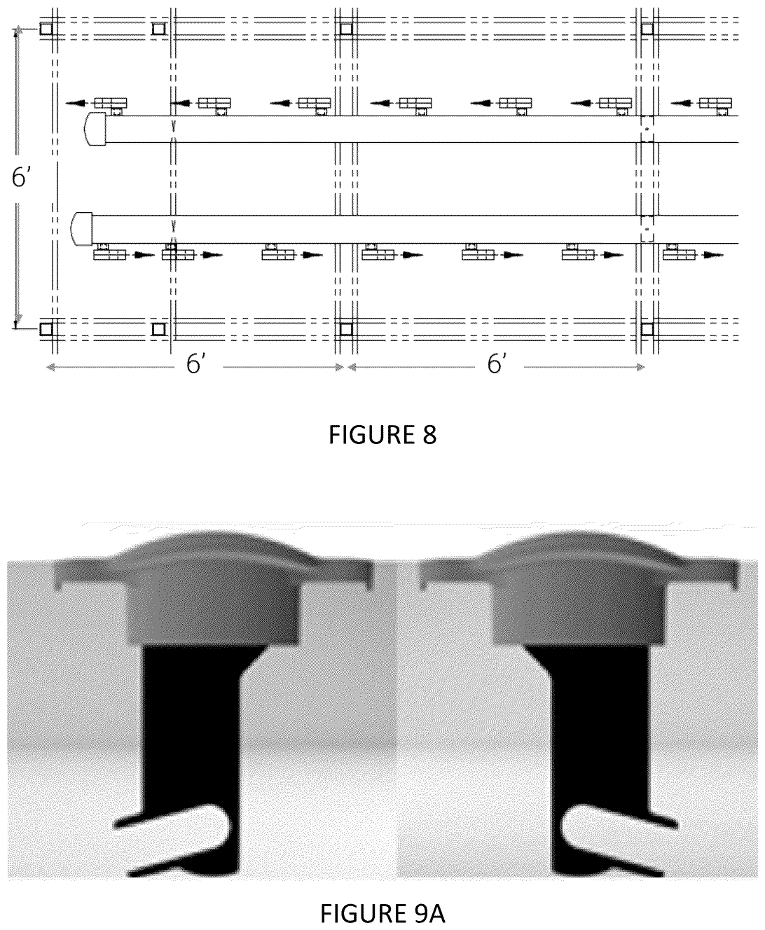

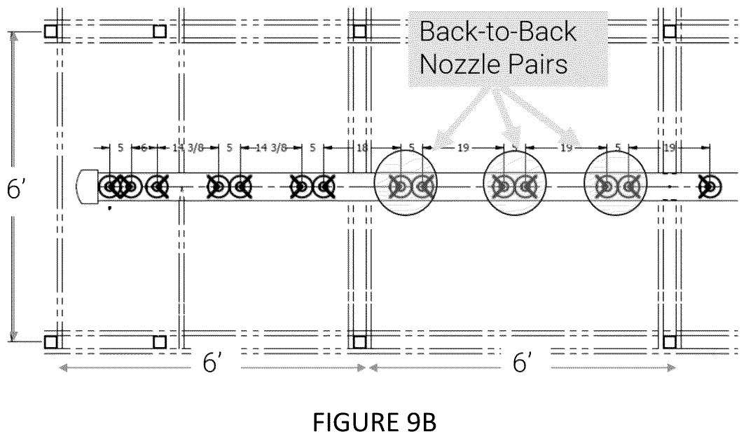

One advantage of the nozzle according to the invention is that where certain evaporative cooling equipment uses two spray branches with prior art nozzles to cover a six foot wide bay (see FIG. 8), the nozzles of the present invention, arranged back-to-back (FIG. 9A), can cover the same area from a single spray branch (see FIG. 9B), reducing material and installation costs.

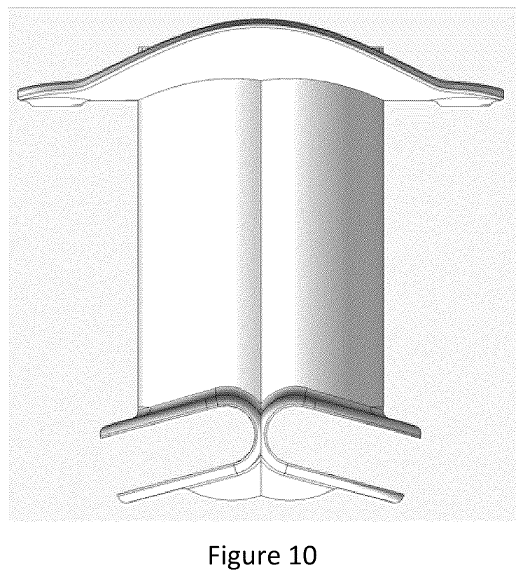

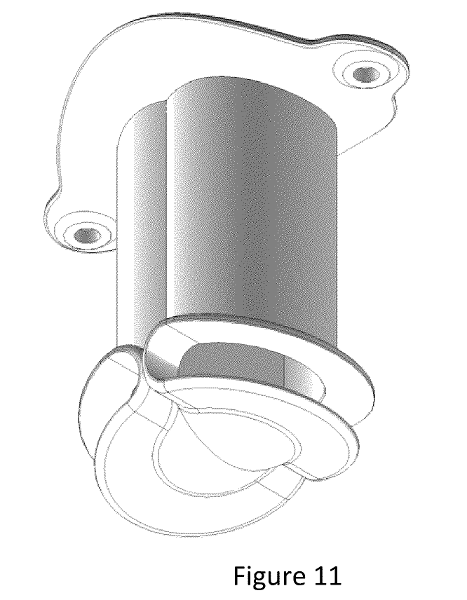

According to a further embodiment of the invention (FIGS. 10 and 11), two nozzles of the first embodiment may be combined into a single body, with the flat portion of each bore's D shape abutting one-another, eliminating the space required between back-to-back nozzles represented in FIG. 9A.

The nozzle of the single body double bore embodiment uses less material and requires fewer nozzles to install. In addition, the nozzle of the single body double bore embodiment is not directional; that is, since its water distribution covers 360 degrees, it cannot be installed backwards, whereas (as noted above) the first embodiment requires careful installation to ensure correct orientation.

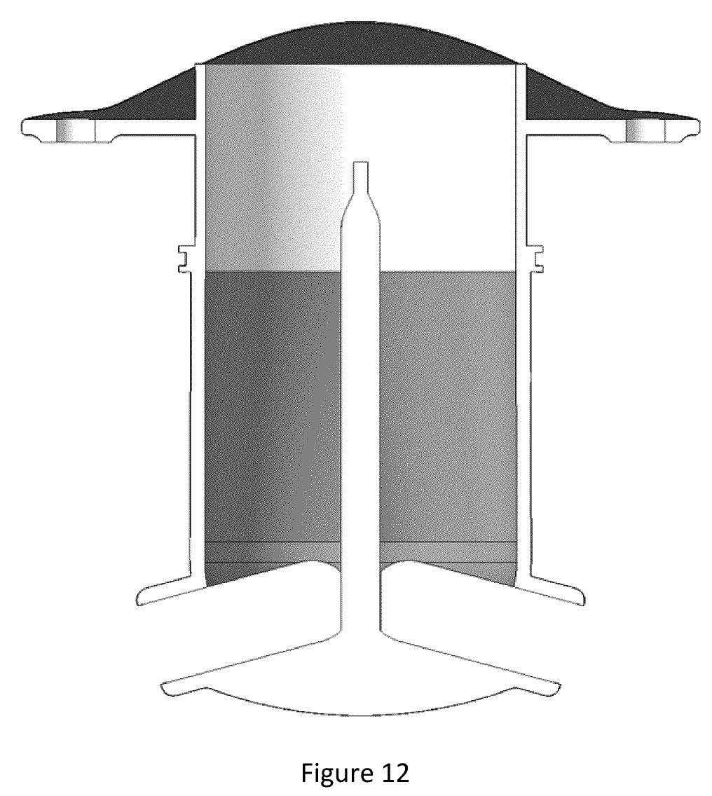

According to a still further embodiment, the single body two-bore device may be constructed with a thickened wall between the flat sides of the two adjacent bores, the top portion of which is tapered on both sides to form two flat/planar slanted surfaces facing in opposing directions, see FIG. 12. The inventors have discovered that the flat/planar slanted surfaces at the top of the wall separating the two bores of the single body device make a significant contribution to even water distribution between the two bores.

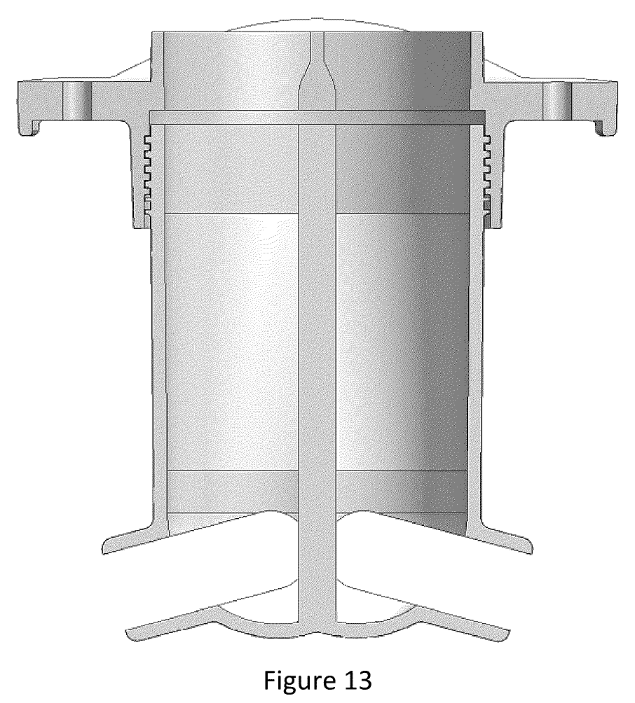

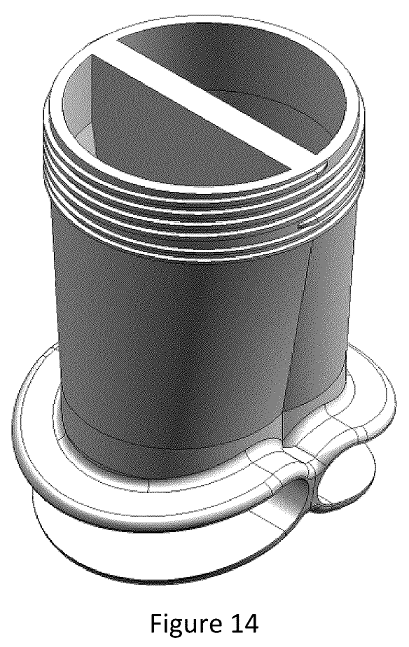

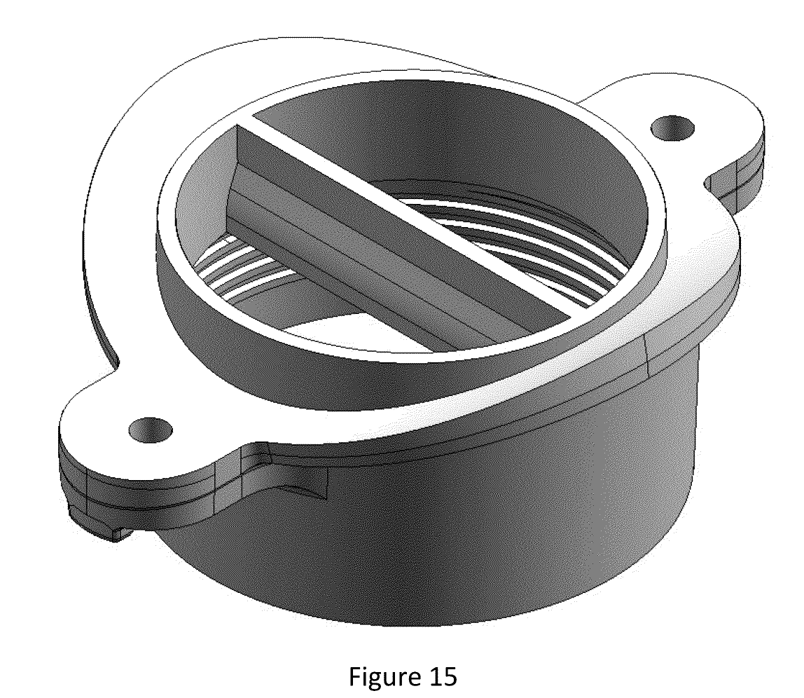

As with the other embodiments disclosed herein, the third embodiment disclosed above may be constructed in two parts, a pipe adapter part and a nozzle part. See FIGS. 13-15. According to this embodiment, a threaded portion of the nozzle part may be received into a threaded portion of the pipe adapter part. The wall separating the flat portions of the two D-shaped bores may extend to the top of the nozzle part (FIG. 14), and the pipe adapter part may include the top part of the wall, including the tapered portion having two flat/planar slanted walls facing opposite directions (FIG. 15). The top portion of the pipe adapter part may have a curved interface adapted to the shape of the pipe to which it is connected by screws or bolts. The threaded interface between the pipe adapter part and the nozzle part allows for quick and easy nozzle replacement in the event of damage or wear.

According to further embodiments of the invention, bore-restricting inserts may be provided to narrow the D-shaped bore(s) for applications where a narrower bore is indicated. Such inserts may be D-shaped, or take other shapes based on the requirements of the adapted nozzle. According to still further embodiments, a D-shaped plug insert may be provided for the double-sided nozzle for applications in which only a single side of the double sided nozzle is required, for example when a nozzle is installed at an end of a unit and/or adjacent a wall.

Notwithstanding the specific embodiments, features, elements, combinations and sub-combinations disclosed herein, it is expressly considered and here disclosed that every single element, every single feature, and every combination and sub-combination thereof disclosed herein may be combined with every other element, feature, combination and sub-combination disclosed herein.

It will be appreciated by those skilled in the art that changes could be made to the embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A heat exchanger water spray nozzle comprising a first D-shaped internal bore.

2. The spray nozzle of claim 1, further comprising a double threaded mating portion configured for mating with an adaptor or a threaded hole in a feed pipe in two pairs of starting and ending positions, configured so that each of two fully threaded orientations are known based on a respective starting orientation.

3. The spray nozzle of claim 1, that delivers identical satisfactory spray patterns both a) when the nozzle is oriented so the spray is directed in a direction of feed water flow and b) when the nozzle is oriented so the spray is directed opposite a direction of feed water flow.

4. The spray nozzle of claim 1, comprising a flat (planar) slanted surface at a top of a flat portion of said first D-shaped internal bore.

5. The spray nozzle of claim 1, comprising a 170 degree or greater spray outlet at a bottom of said first D-shaped internal bore, said 170 degree or greater spray outlet comprising downwardly slanted top flange and a flat downwardly slanted bottom portion that extends into a bottom flange.

6. The spray nozzle of claim 1, comprising a second D-shaped internal bore, said second D-shaped internal bore sharing a flat wall with said first D-shaped internal bore.

7. The spray nozzle of claim 1, comprising a second D-shaped internal bore, and an internal wall separating said second D-shaped internal bore from said first D-shaped internal bore, said internal wall having a top end tapered on both sides to form two flat (planar) slanted surfaces facing in opposing directions.
